(19) United States
(12) Patent Application Publication
(10) Pub. No.: US 2009/0136280 A1
(43) Pub. Date: May 28, 2009

(54) Lottery ticket printer

(75) Inventor: Sam Huang, Banciao City (TW)

Correspondence Address: REED SMITH LLP, Suite 1400, 3110 Fairview Park Drive, Falls Church, VA, 22042, US

(73) Assignee: Armorlink SH Corp.

(21) Appl. No.: 12/071,265

(22) Filed: Feb. 19, 2008

(30) Foreign Application Priority Data
Nov. 28, 2007 (TW) 096220085

(51) Int. Cl. B41J 2/315

(52) U.S. Cl. 400/120.16

(57) ABSTRACT

A lottery ticket printer comprising a base with an opening, a feeding mechanism, a worm gear set, a cam, an actuator and a thermal printer head. The feeding mechanism, the worm gear set and the actuator are disposed in the base. When a lottery ticket is placed at the opening, the feeding mechanism can automatically feed the lottery ticket into the base. The cam is attached to the worm gear set. The actuator is connected to the worm gear set. The thermal printer head is disposed under the cam. When the lottery ticket is inserted into the opening and stops under the thermal printer head, the actuator actuates the worm gear set to rotate, so as to drive the cam to press the thermal printer head down. After printing, the actuator actuates the worm gear set to rotate the cam, so as to lift the thermal printer head upward.

### BACKGROUND OF THE INVENTION

1. Field of the Invention

The invention relates to a lottery ticket printer and, more particularly, to a lottery ticket printer utilizing a worm gear set to decelerate output of a motor, so as to reduce the size of the lottery ticket printer and enhance printing efficiency.

2. Description of the Prior Art

Most of the present lottery tickets are made of thermal paper. The thermal paper is produced by coating a developer layer and a thermal material layer onto a paper. When the thermal paper is heated by a machine, the developer layer will react with the thermal material layer to show images thereon. Once someone wins a lottery, he/she only needs to put the lottery ticket into a lottery ticket printer and the related information is then printed on the lottery ticket.

In general, the lottery ticket printer is always equipped with a thermal printer head for printing information on the lottery ticket. Before putting the lottery ticket into the lottery ticket printer, the thermal printer head is lifted up. After putting the lottery ticket into the lottery ticket printer, the central processing unit (CPU) will control motor, rotating shaft, and so on to press the thermal printer head down to contact the lottery ticket, so as to print information on the lottery ticket. However, the rotational speed of the conventional motor is too fast, so that output of the motor has to be decelerated appropriately. In prior art, there are at least three sets of gears applied to the lottery ticket printer, such that output of the motor can be decelerated more than 26 times. If there are more and more sets of gears disposed in the lottery ticket printer, the following disadvantages will occur.

1) The size of the lottery ticket printer gets larger.

2) The rotation gets slower and then the printing efficiency gets worse.

Therefore, the main scope of the invention is to provide a lottery ticket printer utilizing a worm gear set to decelerate output of a motor, so as to solve the aforesaid problems.

### SUMMARY OF THE INVENTION

A scope of the invention is to provide a lottery ticket printer utilizing a worm gear set to decelerate output of a motor, so as to reduce the size of the lottery ticket printer and enhance printing efficiency.

According to an embodiment of the invention, the lottery ticket printer comprises a base, a feeding mechanism, a worm gear set, a cam, an actuator and a thermal printer head. The base has an opening. The feeding mechanism, the worm gear set and the actuator all are disposed in the base. When a lottery ticket is placed at the opening of the base, the feeding mechanism can automatically feed the lottery ticket into the base. The cam is attached to the worm gear set. The actuator comprises a rotating shaft connected to the worm gear set. The actuator is used for actuating the worm gear set to rotate. The thermal printer head is disposed under the cam.

When the lottery ticket is inserted into the opening of the base and stops under the thermal printer head, the rotating shaft of the actuator rotates to actuate the worm gear set to rotate, so as to drive the cam to press the thermal printer head down. After printing, the rotating shaft of the actuator rotates to actuate the worm gear set to rotate, so as to drive the cam to rotate away from the thermal printer head. Consequently, the thermal printer head is lifted up.

Since the invention utilizes the worm gear set to decelerate output of the motor, it is unnecessary for the invention to install a great deal of gear sets. Accordingly, the size of the lottery ticket printer can be reduced a lot and the printing efficiency can be enhanced a lot as well.

The advantage and spirit of the invention may be understood by the following recitations together with the appended drawings.

### BRIEF DESCRIPTION OF THE APPENDED DRAWINGS

FIG. 1 is a schematic diagram illustrating a lottery ticket printer according to an embodiment of the invention.

FIG. 2 is an inside view illustrating the lottery ticket printer shown in FIG. 1.

FIG. 3 is a schematic diagram illustrating a plurality of rotatable rods.

FIG. 4 is a schematic diagram illustrating the rotatable rods cooperating with each other.

FIG. 5 is a schematic diagram illustrating a worm gear set, a cam and an actuator.

### DETAILED DESCRIPTION OF THE INVENTION

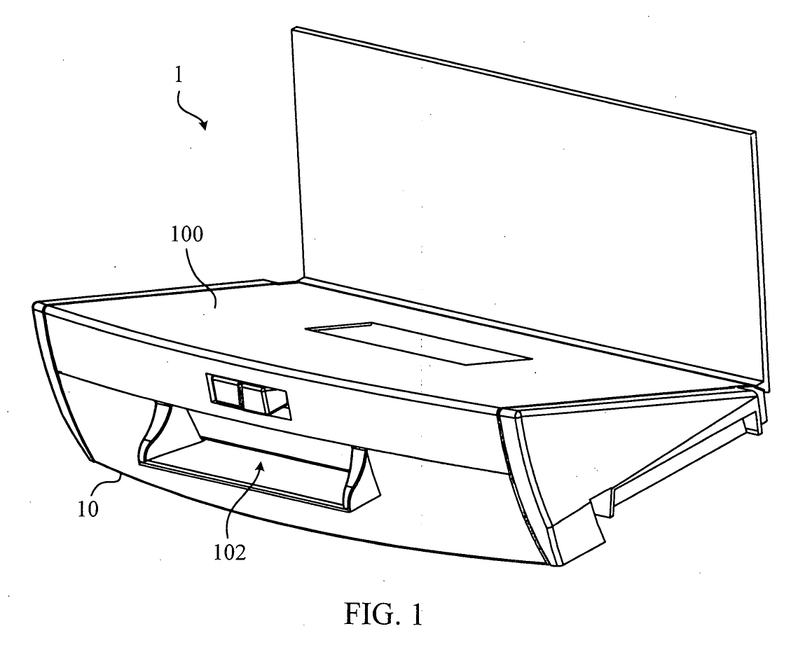

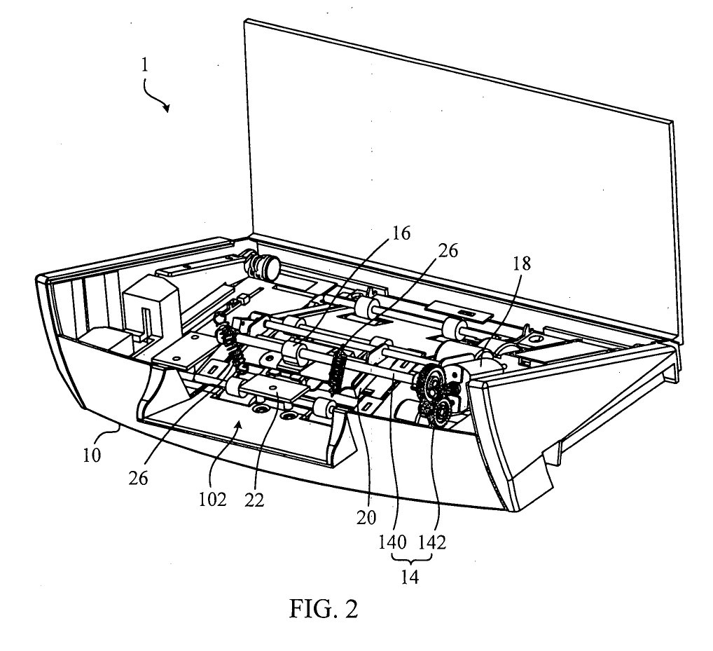

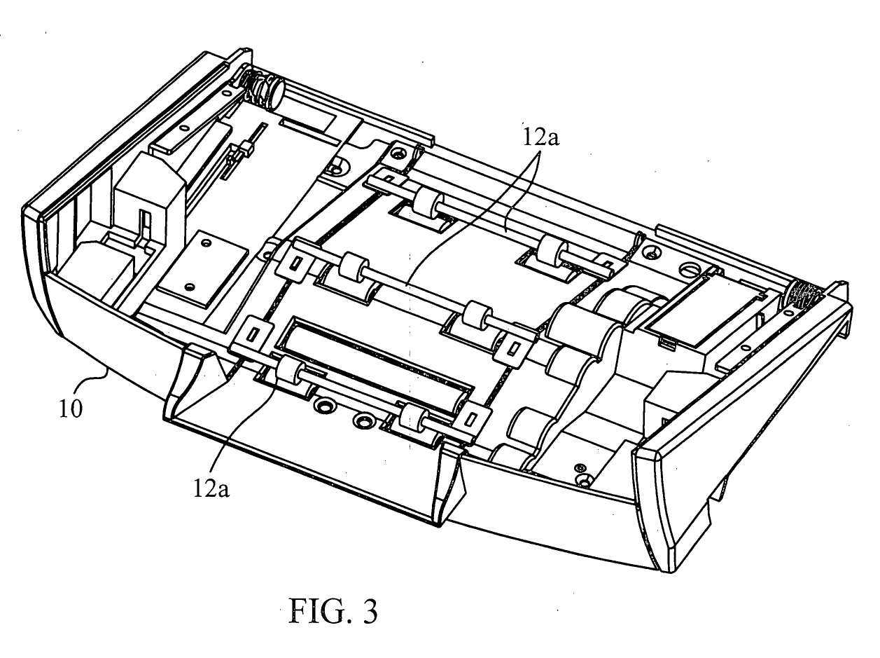

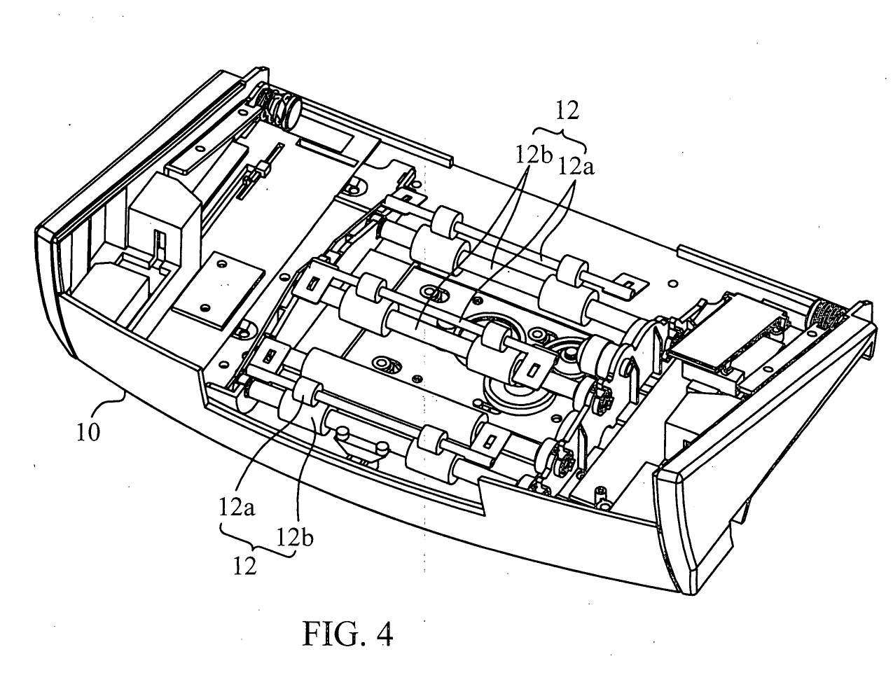

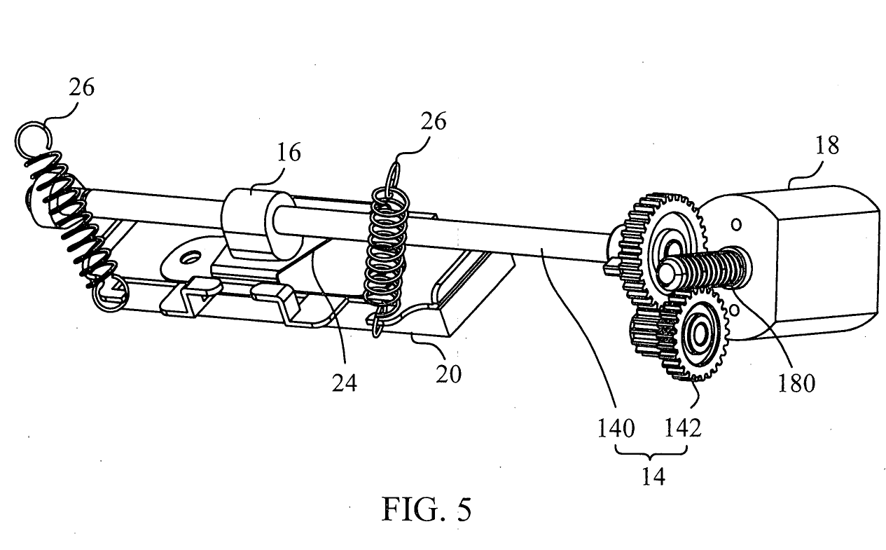

Please refer to FIG. 1 to FIG. 5. FIG. 1 is a schematic diagram illustrating a lottery ticket printer 1 according to an embodiment of the invention. FIG. 2 is an inside view illustrating the lottery ticket printer 1 shown in FIG. 1. FIG. 3 is a schematic diagram illustrating a plurality of rotatable rods 12a. FIG. 4 is a schematic diagram illustrating the rotatable rods 12a cooperating with the rotatable rods 12b. FIG. 5 is a schematic diagram illustrating a worm gear set 14, a cam 16 and an actuator 18.

The lottery ticket printer 1 of the invention comprises a base 10, a feeding mechanism 12, a worm gear set 14, a cam 16, an actuator 18 and a thermal printer head 20. The base 10 has an opening 102. The feeding mechanism 12, the worm gear set 14 and the actuator 18 all are disposed in the base 10. As shown in FIG. 3 and FIG. 4, the feeding mechanism 12 of the invention comprises a plurality of rotatable rods 12a and 12b. The rotatable rods 12a can cooperate with the rotatable rods 12b, so as to roll a lottery ticket (not shown) from the opening 102 into the base 10.

As shown in FIG. 5, the cam 16 is attached to a shaft 140 of the worm gear set 14. A rotating shaft 180 of the actuator 18 is connected to a worm gear 142 of the worm gear set 14 and used for actuating the worm gear set 14 to rotate. The thermal printer head 20 is disposed under the cam 16. In this embodiment, a first resilient member 24 is disposed between the cam 16 and the thermal printer head 20. The first resilient member 24 is forced by the cam 16 to deform, so as to press the thermal printer head 20 down. The actuator 18 can be a motor, such as a stepper motor and so on. The first resilient member 24 can be an elastic sheet or the like.

Furthermore, a cover 100 is disposed over the base 10 and used for covering the base 10. Also, at least one second resilient member 26 is disposed in the lottery ticket printer 1. In FIG. 2 and FIG. 5, there are, but not limited to, two second resilient members 26. One end of the second resilient member 26 is connected to the cover 100 and the other end is connected to the thermal printer head 20. The second resilient member 26 can be a spring or the like.

In this embodiment, a feeding sensor 22 is disposed near the opening 102 of the base 10 and used for sensing the lottery ticket. When the feeding sensor 22 senses that the lottery ticket has been placed at the opening 102 of the base 10, a CPU (not shown) of the lottery ticket printer 1 will drive the feeding mechanism 12 to automatically feed the lottery ticket into the base 10.

When the lottery ticket is inserted into the opening 102 of the base 10 and stops under the thermal printer head 20, the CPU (not shown) will control the rotating shaft 180 of the actuator 18 to rotate and then actuate the worm gear set 14 to rotate, so as to drive the cam 16 to press the thermal printer head 20 down. After printing, the CPU (not shown) will control the rotating shaft 180 of the actuator 18 to rotate again and then actuate the worm gear set 14 to rotate, so as to drive the cam 16 to rotate away from the thermal printer head 20. After the cam 16 rotates away from the thermal printer head 20, the second resilient member 26 will lift the thermal printer head 20 up.

As shown in FIG. 5, provided that an amount of teeth of the worm gear 142 is cleverly tied in with that of the rotating shaft 180, the worm gear set 14 can decelerate speed 26 times and the rotating shaft 180 with straight teeth can decelerate speed 2.5 times, such that output of the actuator 18 can be decelerated 64 times, so as to actuate the cam 16 to rotate.

Compared with the prior art, since the invention utilizes the worm gear set to decelerate output of the actuator (e.g. motor), it is unnecessary for the invention to install a great deal of gear sets. Accordingly, the size of the lottery ticket printer can be reduced a lot and the printing efficiency can be enhanced a lot as well.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A lottery ticket printer comprising:
a base having an opening;
a feeding mechanism disposed in the base, automatically feeding the lottery ticket into the base when a lottery ticket is placed at the opening;
a worm gear set disposed in the base;
a cam attached to the worm gear set;
an actuator, disposed in the base, comprising a rotating shaft connected to the worm gear set, used for actuating the worm gear set to rotate; and
a thermal printer head disposed under the cam;
wherein the rotating shaft of the actuator rotates to actuate the worm gear set to rotate, so as to drive the cam to press the thermal printer head down, and after printing, the rotating shaft of the actuator rotates to actuate the worm gear set to rotate, so as to drive the cam to rotate away from the thermal printer head when the lottery ticket is inserted into the opening and stops under the thermal printer head.

2. The lottery ticket printer of claim 1, wherein the feeding mechanism comprises a plurality of rotatable rods capable of cooperating with each other to feed the lottery ticket into the base.

3. The lottery ticket printer of claim 1, further comprising a feeding sensor, disposed near the opening, for sensing the lottery ticket and enabling the feeding mechanism to automatically feed the lottery ticket into the base.

4. The lottery ticket printer of claim 1, further comprising a first resilient member, disposed between the cam and the thermal printer head, wherein the first resilient member is forced by the cam to deform, so as to press the thermal printer head down.

5. The lottery ticket printer of claim 4, wherein the first resilient member is an elastic sheet.

6. The lottery ticket printer of claim 1, wherein the actuator is a motor.

7. The lottery ticket printer of claim 1, further comprising a cover, disposed over the base, for covering the base.

8. The lottery ticket printer of claim 7, further comprising at least one second resilient member, one end of the second resilient member is connected to the cover and the other end is connected to the thermal printer head, wherein the second resilient member lifts the thermal printer head when the cam rotates away from the thermal printer head.

9. The lottery ticket printer of claim 8, wherein the second resilient member is a spring.

10. The lottery ticket printer of claim 1, wherein the worm gear set comprises a plurality of gears with an amount of teeth different from those of the rotating shaft, so as to decelerate output of the actuator.
